(19) United States
(12) Patent Application Publication
(10) Pub. No.: US 2023/0421383 A1
(43) Pub. Date: Dec. 28, 2023

(54) NODE VERSIONING

(71) Applicant: nChain Licensing AG, Zug (CH)

(72) Inventors: Chloe TARTAN, London (GB); Wei ZHANG, Zug (CH); Craig Steven WRIGHT, London (GB)

(21) Appl. No.: 18/037,032

(22) PCT Filed: Nov. 4, 2021
(86) PCT No.: PCT/EP2021/080613

§ 371 Date: May 15, 2023

(30) Foreign Application Priority Data
Nov. 18, 2020 (GB) 2018105.3

(51) Int. Cl. H04L 9/32; H04L 9/00

(52) U.S. Cl. CPC H04L 9/3247; H04L 9/3236; H04L 9/50

(57) ABSTRACT

A computer-implemented method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises: executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.

### CROSS REFERENCE TO RELATED APPLICATIONS

This application is the U.S. National Stage of International Application No. PCT/EP2021/080613 filed on Nov. 4, 2021, which claims the benefit of United Kingdom Patent Application No. 2018105.3, filed on Nov. 18, 2020, the contents of which are incorporated herein by reference in their entireties.

### TECHNICAL FIELD

The present disclosure relates to a method of executing blockchain transactions.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

Blockchain protocols may use a scripting language for transactions. A script is essentially a list of elements, which may be data or instructions. The instructions are referred to in the literature as, script words, opcodes, commands, or functions. Opcodes (short for operation codes) perform predefined operations on the data within a script.

### SUMMARY

The blockchain is designed to allow various applications to be built upon its infrastructure. Some blockchain nodes provide not only security to the system but also additional functionalities and utilities, such as the ability to execute smart contracts. However not all nodes provide these additional functionalities, or different nodes may support different types or levels of such functionalities. It would be desirable for a node to better facilitate the fact that there may be non-homogeneous node functionality across a blockchain network.

According to one aspect disclosed herein, there is provided a computer-implemented method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises: executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.

According to another aspect disclosed herein, there is provided a computer-implemented method of generating blockchain transactions, wherein the method is performed by a generating entity and comprises: generating a first blockchain transaction comprising a first output, wherein the first output comprises a first locking script comprising a version opcode, wherein the version opcode is configured, so as when executed by an executing entity, to cause the executing entity to obtaining a node protocol version number of the blockchain node, and output the node protocol version number, and wherein the node protocol version number is associated with a particular functionality that the blockchain node is configured to execute.

In response to executing, i.e. calling, a version opcode, a blockchain node obtains and outputs a protocol version number. The protocol version number is associated with a particular protocol that the blockchain node is configured to execute. In other words, the blockchain node is configured to implement functionalities as part of the protocol. For example, the protocol may be a smart contact protocol, or a token protocol, or a particular protocol for validating transactions.

As another example, the blockchain node may be configured to execute non-blockchain specific code (e.g. Python or Java) and return (i.e. output) a result of the execution of said code. The execution of the code may be dependent on data contained in the input of the first transaction.

The validation of the transaction may be at least indirectly dependent on the protocol version number—the transaction must always be valid according to the blockchain protocol enforced by the blockchain node. The introduction of node versioning, i.e. outputting a node protocol version number, can vastly increase the capabilities of nodes of the blockchain network by allowing nodes to view and validate transactions differently according to their own protocols, in addition to the native blockchain protocol. The additional functionality may range from executions of any smart contracts to validation of some specific transactions, from a game of chess to an exchange of assets, or even customised rules for validations.

The version opcode will be referred to below as “OP_VER”. However, the disclosure is not limited to an opcode having that specific label. More generally, while embodiments will be described in terms of “OP_VER” of a blockchain scripting language, the same teaching can be implemented using any opcode which when called by a script engine (e.g. script interpreter) performs a particular function, the function being to cause a protocol version number to be output during execution of a script.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions, and

FIG. 5 illustrates an example system for executing blockchain transactions.

### DETAILED DESCRIPTION OF EMBODIMENTS

### Example System Overview

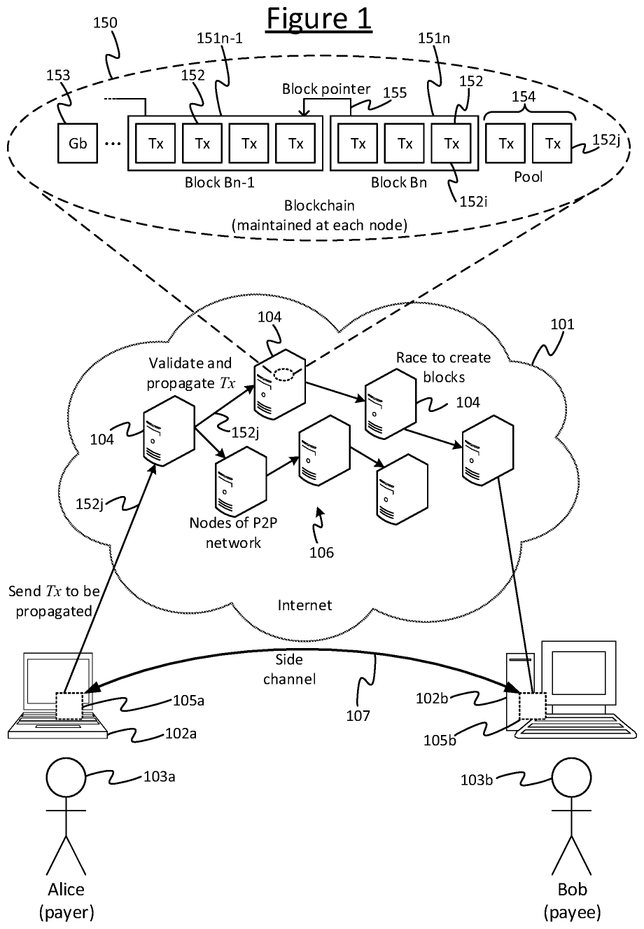

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

UTXO-Based Model

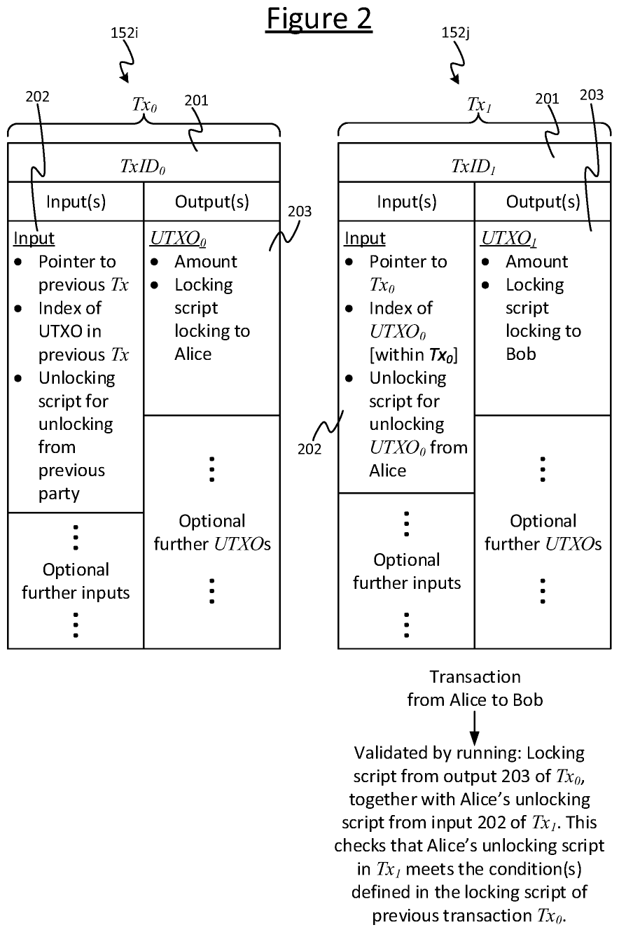

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₂, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

Client Software

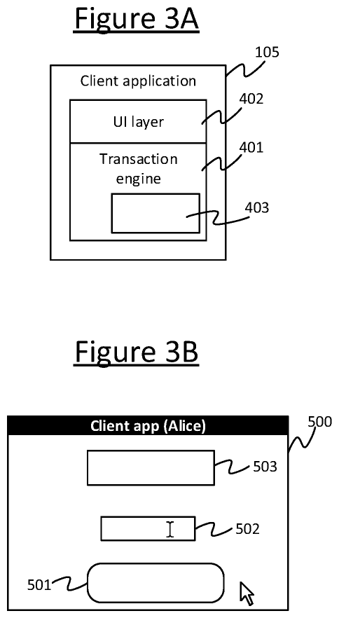

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

Node Software

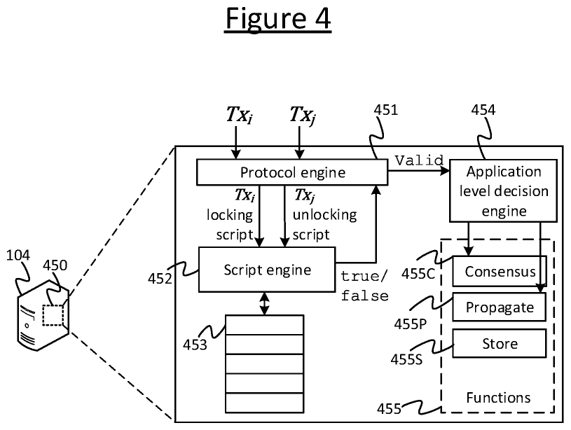

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txⱼ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

OP_VER and Version

The concept of versions on the blockchain varies depending on the context. The following table shows examples of different usage of versions by blockchain nodes at the time of writing.

| Version number | Definition |
|---|---|
| Block version | This is the block version information number contained |
| Size: 4 bytes | within the block header. It is an integer value of fixed 32- |
| Data type: int32_t | bit length. It is set to be 1 at the time of writing. |
| | However, some blockchains uses this value for signalling |
| | and activation of a soft fork upgrade to the consensus |
| | rules. Described in BIP-9, Version bits with timeout and |
| | delay. |
| Transaction version | This is the signed version number in the raw transaction |
| Size: 4 bytes | that currently defaults at 1. Values greater than 1 |
| Data type: int32_t | (nVersion ≥ 2) are used to indicate relative timelocks |
| | that are defined by a sequence number below the |
| | maximum value (0xFFFFFFFF). Described in BIP-68, |
| | Relative lock-time using consensus-enforced sequence |
| | numbers. |
| Message protocol version | This is a number within the version message indicating |
| Size: 4 bytes | the blockchain P2P protocol version of the software that |
| Data type: int32_t | the client “speaks” (70015 at present). The message |
| | protocol version no longer links to the client version |
| | number (i.e., a previous version 106 represents software |
| | 0.1.6), and increments by 1 as changes specified in BIPs |
| | are implemented. Note, version messages were later |
| | upgraded to include checksums. |
| Client version | This is a number in the version message stating the |
| Size: 4 bytes | blockchain server version of the software (e.g., 100000). |
| Data type: int32_t | The “subver” field in the version message is a string of |
| | the type of software running on the client node |
| | (e.g., /Satoshi:0.1.0/). |

The following table documents the history of the OP_VER opcode before it was removed from the source code.

| Bitcoin | | | |
|---|---|---|---|
| Release | Github Reference | Version Value | Notes |
| Bitcoin 0.1.0 | https://github.com/Maguines/Bitcoin-v0.1 | VERSION = 103 | OP_VER reads VERSION and pushes |
| | | (serialize.h) | it to the stack (script.cpp) |
| Bitcoin 0.3.0 | https://github.com/Bitcoin/Bitcoin/tree/v0.3.0 | VERSION = 300 | OP_VER reads VERSION and pushes |
| 4th Jul 2010 | | (serialize.h) | it to the stack (script.cpp) |
| Bitcoin 0.3.3 | https://github.com/Bitcoin/Bitcoin/tree/v0.3.3 | VERSION = 303 | OP_VER reads VERSION and pushes |
| 26th Jul 2010 | | (serialize.h) | it to the stack (script.cpp) |

Bitcoin 0.3.4 and Bitcoin 0.3.5 do not exist

| | | | |
|---|---|---|---|
| Bitcoin 0.3.6 | https://github.com/Bitcoin/Bitcoin/tree/v0.3.6 | VERSION = 306 | OP_VER, OP_VERIF, OP_VERNOTIF |
| 30th Jul 2010 | | (serialize.h) | all return “false”. (script.cpp) |
| Bitcoin 0.3.12 | https://github.com/Bitcoin/Bitcoin/tree/v0.3.12 | VERSION = 312 | OP_VER, OP_VERIF, OP_VERNOTIF |
| 7th Sep 2010 | | (serialize.h) | removed in a cleanup commit |
| | | | (script.cpp) |
| Bitcoin 0.6.0 | https://github.com/Bitcoin/Bitcoin/tree/v0.6.0 | VERSION is changed | Gavin Andresen committed |
| 26th Mar 2012 | | to | “Implement BIP 14: separate |
| | | PROTOCOL_VERSION | protocol version from client |
| | | and has value | version” |
| | | 60000 | |
| Bitcoin 0.6.1 | https://github.com/Bitcoin/Bitcoin/tree/v0.6.1 | PROTOCOL_VERSION | In a commit “version.h: separate |
| 30th Apr 2012 | | was moved from | client, net sections. Move more |
| | | serialize.h to | constants to this file” by Jeff |
| | | version.h and took | Garzik. Note that serialize.h does |
| | | value 60001. | include version.h |

From this point in time onwards (i.e. in the history of the prior art), the variable “PROTOCOL_VERSION” is taken to be the message protocol version. Whenever there is a change in messaging protocol, “PROTOCOL_VERSION” increments by 1. The rest of the history can be summarised in the table below.

| Release | PROTOCOL_{—} | | Commit | |
|---|---|---|---|---|
| Version | VERSION | Github Commit Message | Date | Link |
| 0.7.0 | 60002 | Add ‘mempool’ P2P command and extend | 31^{st} Jul | https://github.com/Bitcoin/Bitcoin/tree/v0.7.0 |
| | | ‘getdata’ behaviour to permit | 2012 | |
| | | downloading of mempool transactions | | |
| | | from the remote peer. | | |
| 0.8.0 | 70001 | Bump PROTOCOL_VERSION for filter | 13^{th} Aug | https://github.com/Bitcoin/Bitcoin/tree/v0.8.0 |
| | | messages. | 2012 | |
| 0.9.0 | 70002 | | | https://github.com/Bitcoin/Bitcoin/tree/v0.9.0 |
| 0.12.0 | 70012 | Allow block announcement with header | 29^{th} Nov | https://github.com/Bitcoin/Bitcoin/tree/v0.12.0 |
| | | | 2015 | |
| N/A | 70013 | Implement “feefilter” P2P message. The | 12^{th} Feb | N/A |
| | | “feefilter” p2p message is used to inform | 2016 | |
| | | other nodes of your mempool min fee | | |
| | | which is the feerate that any new | | |
| | | transaction must meet to be accepted to | | |
| | | your mempool. This will allow them to | | |
| | | filter invs to you according to this feerate. | | |
| 0.13.0 | 70014 | Add protocol messages for short-ids | 6^{th} Jun | https://github.com/Bitcoin/Bitcoin/tree/v0.13.0 |
| | | blocks | 2016 | |
| 0.14.0 | 70015 | Bump the protocol version to distinguish | 1^{st} Nov | https://github.com/Bitcoin/Bitcoin/tree/v0.14.0 |
| | | new banning behaviour. This allows future | 2016 | |
| | | software that would relay compact blocks | | |
| | | before full validation to announce only to | | |
| | | peers that will not ban if the block turns | | |
| | | out to be invalid. | | |

To summarise, at no point has the OP_VER opcode been configured to cause a blockchain node to output a node protocol version number, where the node protocol version number is associated with a respective node protocol that the node is configured to implement. The node protocol version number may be a 4 byte number having a int32_t data type.

Moreover, whilst the “message protocol” has been referred to as a “node version”, the message protocol is inherently different to that of the newly defined node protocol version, as detailed in the tables above.

Put another way, previously OP_VER was only used to output a number of a messaging protocol used by nodes to communicate with one another. In contrast, the present invention outputs a number associated with additional functionality that the node is configured to implement.

The additional functionality that the node is configured to execute may be triggered (brought about) by processing (i.e. validation) of the transaction. This is contrasted with a messaging protocol which is not triggered by such processing.

The additional functionality may be functionality that the node is configured to provide to an entity other than a mining node, e.g. clients of the node, such as Alice 103a and Bob 103b.

Node Protocol Version

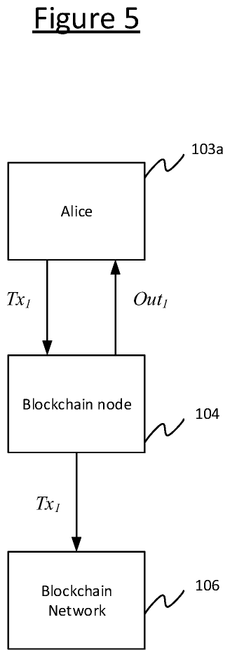

Embodiments of the present invention enable blockchain nodes to offer additional functionalities based on their respective node protocol versions. FIG. 5 illustrates an example system 500 for implementing some embodiments. As shown, the system 500 comprises a transaction generator, Alice 103a, a blockchain node 104 and the blockchain network 106. Of course, the blockchain node 104 is also part of the blockchain network. The system 500 may comprise additional parties, e.g. additional users such as Bob 103b.

The blockchain node 104 is configured to execute blockchain transactions. That is, the blockchain node is configured to execute a locking script of a first (i.e. previous) transaction together with an unlocking script of a second (i.e. later) transaction. At least the first transaction is generated by Alice 103a and include, in an output of the transaction, a locking script containing a version opcode. The locking script may comprise additional opcodes and/or data. For instance, as described later, the locking script may comprise a target node protocol version number. The second transaction may also be generated by Alice 103a, or by a different party, e.g. Bob 103b. The second transaction contains an input that references the output of the first transaction. The input of the second transaction may contain data such as one or more public keys and/or one or more digital signatures. Generally the input of the second transaction may contain any type of data.

During execution of the transactions, i.e. the locking and unlocking scripts, the version opcode will be executed, i.e. called. In response to calling the version opcode, the blockchain node 104 is configured to obtain (i.e. read) a node protocol version number from memory of the blockchain node 104. In general the node protocol version number may be stored in any type of memory, i.e. computer-readable storage. Having obtained the node protocol version number, the blockchain node 104 is also configured to output the node protocol version number. The node protocol version number indicates a particular protocol, i.e. functionality or capability, that the blockchain node 104 is configured to provide.

Note that the node protocol version number is not limited to being represented using integers, and may instead comprise both letters and integers. E.g. the node protocol version number may be represented in hexadecimal.

For completeness, note that the node protocol version number is not any of the following: the block version number, the transaction version number, the message protocol version, or the client version number.

The blockchain node 104 may execute the blockchain transaction as part of a transaction validation process. E.g. during the process of validating transaction for the purposes of block construction, or for the purpose of validating transactions that have been published in a new block by a different node of the blockchain network 106.

In some examples, the blockchain node 104 may output a fixed-length representation of the node protocol version number instead of the node protocol version that is obtained from memory. E.g. the stored node protocol version may be of a larger length (e.g. six bytes) but only the first four bytes are output.

The locking and unlocking scripts may be written in a stack-based scripting language, such as Script. In these examples, outputting the node protocol version number may comprise outputting the version number to a stack, e.g. a main stack or an alternative (i.e. secondary) stack.

It is also not excluded that the node protocol version number may be output in alternative ways, such as by being included in a new transaction generated by the blockchain node 104, or by being transmitted to Alice 103a and/or or Bob 103b, e.g. via a side channel, or by being published, e.g. on the internet.

The version opcode may take one of several forms. Each form of the version opcode is configured, so as when executed by the blockchain node 104, to cause the blockchain node 104 to output its node protocol version number from memory.

Another form of the version opcode (referred to below as a version verification opcode) causes an additional action to be taken. Specifically, when executing the version verification opcode, the blockchain node 104 verifies that the output node protocol version number matches a target node protocol version number included in the locking script of the first transaction or the unlocking script of the second transaction. For example, the locking script may include the target node protocol version number and the version verification opcode, e.g. the version verification opcode may immediately follow the target node protocol version. When the version verification opcode is executed, the output node protocol version number is checked for exactness against the target node protocol version.

In some examples, the locking script of the second transaction may comprise a portion of code that is only executed if the output node protocol version number matches the target node protocol version number. In these examples, if the output node protocol version does not match the target node protocol version number then that portion of code is not executed.

For instance, if some data is nested in an if statement where the output node protocol version number must match the target node protocol version number, then a non-matching node would not execute (i.e. ignore) this portion of script and validate the transaction as usual according to the blockchain validation rules.

In alternative examples, the locking script of the second transaction may comprise a portion of code that is only executed if the output node protocol version number does not match the target node protocol version number. In these examples, if the output node protocol version does match the target node protocol version number then that portion of code is not executed.

In some examples, the blockchain node 104 may be configured to output and/or store in memory an outcome (e.g. a result) of the portion of code that is executed. Here, outputting may comprise outputting to a stack. Additionally or alternatively, outputting may comprises sending to one or more of Alice 103a, Bob 103b and/or the blockchain network 106

In some examples, the outcome of the execution of the portion of code may be included in a blockchain transaction. For example, the outcome may be published in a new transaction. As another example, the blockchain node 104 may receive an unpublished version of the second transaction that reference the output of the first transaction comprising the portion of code and the version verification opcode. After executing the portion of code, the blockchain node 104 may record the result in an output of the second transaction and publish the second transaction. In other words, the second transaction is updated to include the result before being made available to the blockchain network 106.

The portion of code may be written in the native blockchain scripting language, e.g. Script. I.e. the portion of code may comprise data and/or opcodes of the native scripting language. For example, the portion of code may comprise a blockchain address and a script for requiring an unlocking script to include a corresponding public key and signature, as is the case for pay-to-public-key-hash (P2PKH) outputs.

In other examples, the portion of code may be written in a non-native scripting language, i.e. a scripting language native to a different blockchain. For example, the native scripting language may be native to the Bitcoin blockchain, whilst the non-native scripting language may be native to the Ethereum blockchain.

In some examples, the portion of code may be written in a non-blockchain language, i.e. a language that is not specific to any blockchain. For example, the portion of code may be written using a programming language such as C, C++, Go, Ruby, Python, Java, JavaScript, etc.

In addition to users, such as Alice 103a and Bob 103b, generating transactions comprising a version opcode (e.g. the version verification opcode), the blockchain node 104 may also generate a transaction that comprises a verification opcode. For example, the blockchain node 104 may generate a transaction that comprises, as part of a locking script, a version verification opcode that checks whether an output node protocol version number matches a target node protocol version number included in the locking script by the blockchain node 104. The locking script may comprise a portion of code that is only executed if, when the version verification opcode is called by a node 104 that executes the transaction, the output node protocol version number corresponds to the target node protocol version number. The portion of code may comprise a locking condition, e.g. one based on a public key or a public key hash.

The target node protocol version number may correspond to a protocol that the blockchain node 104 is configured to implement. For example, the protocol may be a transaction validation protocol. Alternatively, the protocol may be a smart contract protocol or a token protocol. Building on the example of the protocol being a token protocol, the transaction generated by the blockchain node 104 may be a transaction that creates, i.e. mints, an amount of tokens. The token creation transaction may instead be created by a token issuer.

The first and second transactions discussed above may also be token transactions. For example, the first transaction may be a token creation transaction that newly mints an amount of tokens. The second transaction may be a token spend transaction that spends an amount of those tokens. The first transaction does not necessarily have to be a token creation transaction and instead may also be a token spend transaction that spend an earlier token transaction.

Each token transaction (creation or spend) comprises, as part of the same locking script, a token locking condition in addition to a blockchain locking condition, i.e. a locking condition that is independent of the token protocol. The token locking condition is only executed during execution of the token transactions if the node protocol version number output in response to calling the version opcode matches the token protocol version number included in the token transaction. In order for an amount of tokens to be spent, the token spend transaction must satisfy the two separate locking conditions.

As well as creating and/or validating token transactions, the blockchain node 104 may construct and publish token blocks. A token block comprises a record of the token transactions (i.e. blockchain transactions comprising the token protocol version number) that are included in a given blockchain block. Only one token block is constructed per blockchain block. The blockchain node 104 may construct a token block for each newly published blockchain block, i.e. starting from a particular time or block. Each token block may comprise one or more of the following data items: the target node protocol version number associated with the token protocol, each transaction comprising the target version number and published in the respective blockchain block, a sum of the number of transactions contained in the token block, a Merkle root calculated based on the transactions included in the token block, and a previous block header based on a hash of a previous token block constructed based on a corresponding previous blockchain block.

Further specific examples of the described embodiments will now be described.

At the time of writing, OP_VER and the relevant opcodes are not implemented. According to some embodiments, OP_VER is now defined according to the following table.

| Word | Opcode | Hex | When used . . . |
|---|---|---|---|
| OP_VER | 98 | 0x62 | It reads the node protocol version number from a local file |
| | | | (This file used to be serialize.h.) |
| | | | It checks and converts the value to a 4-byte number. |
| | | | It pushes the number to the stack. |
| OP_VERIF | 101 | 0x65 | It is equivalent to OP_VER OP_EQUAL OP_IF. |
| OP_VERNOTIF | 102 | 0x66 | It is equivalent to OP_VER OP_EQUAL OP_NOTIF. |

As OP_VER reads some local value and pushes it to the stack when a transaction is validated, it may be important that the value pushed to the stack is of a well-defined format and presents no harm. An analogy of this is the injection attack via URL or SQL, where commands to manipulate the database maliciously are sent as parameters of URL or SQL.

To prevent the attack, we can set the value that is pushed to the stack to be a data type. This is, we define OP_VER to do the following:
1. Read the node version number from a local file and convert it to a 4-byte representation, denoted as version
2. Use the following mechanism to push the value to the stack:
   OP_PUSHDATA1 04 version
where OP_PUSHDATA1 indicates that the next byte contains the number of bytes to be pushed onto the stack, which is 4. Then a four-byte data “version” representing the node version number is pushed to the stack. If the node version number is set to be more than 4 bytes, the implementation can either just take the first 4 bytes as version or report an error and halt the execution immediately. By doing this, any attempt to inject opcodes maliciously will fail as the opcodes are formatted as neutral 4-byte data. Therefore, when calling OP_VER, a 4-byte data will be pushed to the stack as described above.

One practical consideration is the version assignment. The question here is who decides the assignment of a node version number to a node protocol. It might be natural to think that we need a central authority to manage the assignments. However, given the economic incentive for example, then the market may instead sort out this matter by itself.

To see why it is not an issue, first note that the node version number does not have to be the only trigger of a protocol validation. After OP_VERIF gives TRUE, the protocol can introduce a secondary trigger or check on the content that followed OP_VERIF, say a passcode, a digital signature, or the format.

In addition to that, there can be a service that provides users the visibility of the assignments of the node version number. Note that the service does not manage the assignments. It just truthfully shows the assignments to the public. If there is a clash, it will be shown as well. The protocol owner or designer will have the incentive to avoid a clash if it causes a problem.

When OP_VER is enabled, nodes 104 can choose which protocols they support. We assume that each node is supporting the native blockchain protocol. That is, every transaction must be blockchain valid before it can be passed to the overlay protocol validation. Suppose, a node 104 supports a protocol that executes smart contracts on Ethereum, and the corresponding node version number is “0x2abc”. The node 104 makes sure that the configuration file has “NODE_VERSION=0x2abc”. When a user, say Bob 103b, would like to have his Ethereum contract validated as part of a blockchain transaction, he creates a transaction that spends an outpoint with the following locking script:

[P2PKH script]
<0x2abc> OP_VERIF
<encoding of the Ethereum transaction>
OP_ENDIF

When the node 104 receives this transaction, OP_VERIF will pick up its node version and compare it with what is in the locking script. As it matches, the Ethereum transaction will be read and validated. If it passes, the Ethereum transaction will be relayed to the Ethereum network and mined.

When other nodes receive Bob's transaction, as their node version numbers do not match, they will skip the content in the second branch and treat it as a standard P2PKH transaction. Now consider the case that there is a version clash, where a different node has a node version number “0x2abc” too for which it is used to validate transactions that contain exchanges of tokens for unwanted Christmas gifts. That different node will proceed to read the content after OP_VERIF for Bob's transaction. However, it is likely that the different node will find the content does not comply with the format required for the token exchange, and therefore reject the transaction as an invalid token exchange. Similarly, the first node will reject transactions that the different node determines to be valid.

In the case where the legality of signatures plays an important role, OP_CODESEPARATOR can be used to avoid dispute. One can simply rearrange the branches as the following:

<0x2abc> OP_VERIF
<encoding of the Ethereum transaction>
OP_ENDIF
OP_CODESEPARATOR [P2PKH script]

The opcode OP_CODESEPARATOR will allow the signer who is trying to unlock “[P2PKH script]” to only sign the content that goes after OP_CODESEPARATOR. This is important when the first branch, say, the encoding of the Ethereum transaction, contains some illegal content or some misstatement. A signature from the spending transaction would have signed, hence approved or attested the illegal content or the misstatement, if OP_CODESEPARATOR was not used.

In the example given above, the blockchain nodes 104 provide a service that validates and relays Ethereum transactions. In order to facilitate this, the node 104 must maintain an active Ethereum node that is connected to the Ethereum network. Locally, the node 104 needs a tool that reads the data from the Bitcoin transaction and feeds the data to the Ethereum validation tool. This can be costly to the node 104. However, when the Ethereum network is crowded with transactions, it will take a long time for a user to see their transaction being mined. By having a dedicated validator, i.e. the node 104 from the Bitcoin network 106, a user can check almost instantly whether their Ethereum transaction is valid or whether the execution of their smart contract is successful and as expected. If so, they know that it will be mined eventually. That is, the node 104 not only validates and relays valid Ethereum transactions for its customers, but also checks any unintended errors in the construction of the transactions for her customers by feeding back the validation outcomes.

Commensal Token Chain In this section, we describe an optional new token system that inherits all the existing functionalities and features of the blockchain as well as some extra functionality. The system forms a commensal chain in relation to the blockchain chain and will be called a token chain from now on. Note that the commensalism refers to the fact that the token chain benefits from the blockchain while the blockchain is unaffected by the token chain.

A token chain has a token UTXO set, where the token UTXO set will be a subset of the overall blockchain UTXO set. Also, a token chain has a token mempool, where the token mempool will be a subset of the overall blockchain mempool.

As a token enabled blockchain node (TEBN), they just need to distinguish a token transaction from a non-token transaction and flag them accordingly. In terms of storage, a TEBN may need to store an extra bit for each transaction they process, which is almost negligible.

When receiving a blockchain transaction, a TEBN validates it input-wise:
If the validation is successful in respect to the Bitcoin rules, they will check whether the input is in the token UTXO set.
If it is, then they will read the execution result from the alt stack.
If the result is true, then they move on to the next input.

In these embodiments, a transaction can only be put into the token mempool if all inputs are in the token UTXO set and the execution results are true from the alt stack. The token mempool can be considered the set of transactions that are in the blockchain mempool and are flagged as token transactions. The same applies to the token UTXO set.

Note that the script validation for the token transactions are integrated to the blockchain script validation using OP_VER and the alt stack. More detail will be covered in the description of a token life cycle below.

Note that in the described token system, token-enabled blockchain nodes are blockchain nodes, but they do not need to do any extra proof of work. The additional actions that a token-enabled blockchain node may perform are:
1. to validate token transactions,
2. to keep a record of valid token transactions, and
3. to respond to a token transaction query such as a token UXTO membership query.

Suppose a token issuer, say Alice 130a, would like to issue tokens that represents units of gold; and Bill, a blockchain node 104, offers his commensal token solution to Alice 103a. Bill 104 sets his node version to be 0x901d which would be read by OP_VER during transaction validations.

Alice 103a can choose to publish the specification of her tokens on-chain in an OP_FALSE OP_RETURN payload in a genesis token transaction. This will allow Alice 103a to open the token chain to the public. Whenever there is a dispute, the token users, including Alice 103a, can refer to the specification to settle the dispute. The specification can reference ERC-20 standards, Tokenised standards, or any customised standards which the token issuer feel appropriate.

Note that some rules in the specification will require token nodes to perform extra checks. This has to be done in an agreement between the token nodes and the token issuer.

One important implication of this system is the value representation of the quantity of the tokens in a token transaction. We assume that the quantity of the tokens in a token transaction is linked to the value represented by the output of that token transaction (it is worth noting that this is not a strict requirement; an alternative scheme may be one where the token value is recorded within the OP_VER branch). The token issuer can setup and fix a linear function ƒ(x) in the specification, where x is the number of satoshis in the output of the token creation transaction. We insist the function to be linear as we want to have the property that ƒ(x+y)=ƒ(x)+ƒ(y) for all integers x and y.

There are two approaches to creating tokens:
1. Create tokens in coinbase transactions. In this case, the tokens are minted by blockchain nodes 104. However, there is extra proof of work required.
2. Create tokens in a blockchain transaction by a token issuer.

Both approaches will use similar locking scripts in the creation transactions. An example is given below:

TxID₁

| Version | 1 | Locktime | 0 |
|---|---|---|---|
| In-count | 1 | Out-count | 1 |
| Input list | | Output list | |
| Outpoint | Unlocking script | Value | Locking script |
| Alice's | < Sig_{A} > | x satoshi | OP_DUP OP_HASH160 <H(PK₁)> |
| outpoint | < PK_{A} > | | OP_EQUALVERIFY OP_CHECKSIG |
| | | | <0x901d> OP_VERIF |
| | | | OP_ROT OP_ROT OP_DUP |
| | | | OP_HASH160 <H(PK₂)> |
| | | | OP_EQUALVERIFY OP_CHECKSIG |
| | | | OP_TOALTSTACK |
| | | | OP_ENDIF |

If this transaction is created by a TEBN as a coinbase transaction, then the input would be omitted, and an extra output would likely to be added to claim the rest of the block reward and the transaction fees. That is, “x satoshi” is taken from the sum of the block reward and the transaction fees. For now, the important part is the locking script in the token output.

There are two OP_CHECKSIG opcodes in the locking script.
1. The first one is used to lock the native blockchain value represented by this output.
2. The second one is used to lock the token value represented by this output.

To unlock the native blockchain value, only one signature is required, <Sig₁><PK₁>. To unlock the token value, two signatures are required, <Sig₂><PK₂> and <Sig₁><PK₁>.

To generalise this idea, we define the blockchain locking condition to be the condition in the locking script that locks the native blockchain value, and the token locking condition to be the condition that is encapsulated by OP_VERIF and OP_ENDIF.

Note that, to unlock a token, one needs to meet both the blockchain locking condition and the token locking condition. The purpose of the OP_VER branch is to add extra validations in addition to the blockchain validation without invalidating any valid blockchain transaction. To summarise, we have the following truth table:

| Bitcoin Validity | OP_VER Branch Verification | Token Validity |
|---|---|---|
| TRUE | TRUE | TRUE |
| TRUE | FALSE | FALSE |
| FALSE | TRUE | FALSE |
| FALSE | FALSE | FALSE |

If the token owner accidentally creates a transaction that is blockchain valid and token invalid, then he or she effectively burns the token. In some token systems, the token issuer will be able to re-issue the token to the owner by minting a new token or transferring a token to the owner from a reserve. However, this type of issue can be avoided by token wallets which will check the validity of unlocking scripts before sending the transactions to the network.

Given this generalisation, we can have the blockchain locking condition to be unlocked only by the token issuer, or only by the token owner, or 1-out-of-2 multi-sig between the issuer and the owner. The token locking condition can also be flexible. One can have multiple owners sharing some tokens with a threshold locking condition.

Similar to the genesis block, this transaction will be the genesis token transaction in the genesis token block on the token chain. When it is on the token chain, we can start to describe how the locking script works when being unlocked in detail i.e., to spend the token or to transfer the token ownership.

Consider the following transaction, TxID₂, which spends TxID₁.

TxID₂

| Version | 1 | Locktime | 0 |
|---|---|---|---|
| In-count | 1 | Out-count | 1 |
| Input list | | Output list | |
| Outpoint | Unlocking script | Value | Locking script |
| TxID₁ | < Sig₂ >< PK₂ > | x satoshi | OP_DUP OP_HASH160 <H(PK₃)> |
| \|\| 0 | < Sig₁ >< PK₁ > | | OP_EQUALVERIFY OP_CHECKSIG |
| | | | <0x901d> OP_VERIF |
| | | | OP_ROT OP_ROT OP_DUP |
| | | | OP_HASH160 <H(PK₄)> |
| | | | OP_EQUALVERIFY OP_CHECKSIG |
| | | | OP_TOALTSTACK |
| | | | OP_ENDIF |

When receiving TxID₂, Bitcoin nodes will execute the full script as: <Sig₂><PK₂><Sig₁><PK₁>OP_DUP OP_HASH160<H(PK₁)>OP_EQUAL OP_CHECKSIG<0x901d>OP_VERIF OP_ROT OP_ROT OP_DUP OP_HASH160<H(PK₂)>OP_EQUAL OP_CHECKSIG OP_TOALTSTACK OP_ENDIF.

A normal blockchain node whose node version is not set to 0x901d will validate the script as:

| | | | | | | |
|---|---|---|---|---|---|---|
| PK₁ | OP_DUP | true | | 0x901d | | true |
| Sig₁ | OP_HASH160 | PK₂ | | true | OP_VERIF | PK₂ |
| PK₂ | <H(PK₁)> | Sig₂ | <0x901d> | PK₂ | ... | Sig₂ |
| Sig₂ | OP_EQUALVERIFY | | | Sig₂ | OP_ENDIF | |
| | OP_CHECKSIG | | | | | |

Note that OP_VERIF is effectively OP_VER OP_EQUAL OP_IF. The top stack would show false after OP_EQUAL. However, the “false” element will be consumed by OP_IF. Hence, the top stack shows true after execution, and the validation of the script is considered successful. Suppose the input is still in the blockchain UTXO, then the transaction will be accepted to the blockchain mempool to be included in a block.

On the other hand, a token enabled blockchain node whose node version is 0x901d will validate the transaction as:

| | | | | | | | |
|---|---|---|---|---|---|---|---|
| PK₁ | OP_DUP | true | | 0x901d | | 0x901d | |
| Sig₁ | OP_HASH160 | PK₂ | | true | | 0x901d | |
| PK₂ | <H(PK₁)> | Sig₂ | <0x901d> | PK₂ | OP_VER | true | OP_EQUAL |
| Sig₂ | OP_EQUALVERIFY | | | Sig₂ | | PK₂ | |
| | OP_CHECKSIG | | | | | Sig₂ | |
| true | | true | | PK₂ | OP_DUP | true | |
| true | | PK₂ | OP_ROT | Sig₂ | OP_HASH160 | true | |
| PK₂ | OP_IF | Sig₂ | OP_ROT | true | <H(PK₂)> | | OP_TOALTSTACK |
| Sig₂ | | | | | OP_EQUAL | | |
| | | | | | OP_CHECKSIG | | |
| true | true | | | | | | |
| Main Stack | Alt Stack | | | | | | |

For the token enabled blockchain node, they read the top element on the main stack for the result of the blockchain validation, and the top element on the alt stack for the result of the token validation. If both are true, then validation is successful. They check whether the input is in both the blockchain UTXO set and the token UTXO set. If it is, then the transaction is accepted to both the blockchain mempool and the token mempool, or effectively, to the Bitcoin mempool and marked as a token transaction.

If the main stack shows true and the alt stack show false, the transaction will be added to the blockchain mempool, but not be added to the token mempool. In this case, the relevant tokens are burned once the transaction is published on the blockchain. If the transaction is blockchain invalid, then it is rejected without the need to read from the alt stack.

A token block is constructed as soon as a new blockchain block is published Given a newly published blockchain block:

| | |
|---|---|
| Block Version | 0x00000001 |
| Prev_Block | 000000000000000000123456789912345678fe123456786cc1234123488d3f0c7 |
| Merkle_Root | 1234567891234567814159265359143c203141592653598a63814159265359 |
| Timestamp | 2021-02-04 10:50:50 utc |
| Difficulty_Bits | 18027387 |
| Nonce | 3141592653 |
| Tx_Count | 718281 |
| Txs | TxID₁, TxID₂, . . . , TxID₇₁₈₂₈₁ |

The following token block would be constructed:

| | |
|---|---|
| Version | 0x901d0000 |
| Prev_Block | Double SHA256 of pervious token block |
| | header |
| Merkle_Root | MRₜₒₖₑₙ |
| Bitcoin_Block_Height | 672038 |
| Tx_Count | 4 |
| Txs | TxID₁, TxID₂, TxID₃, TxID₄ |

1. We use the node version field to indicate which token chain the block belongs to.
2. The previous block hash will be the hash value of the previous block header. Note that there is no proof of work required here.
3. The Merkle root is calculated from the transactions that are included in the token block.
4. We use a new field called blockchain block height to indicate to which blockchain block all the token transactions belong.
5. The transaction count indicates how many transactions there are in the token block.
6. The full list of transactions is listed in the transactions field.

Note that the token block header consists of the first five fields in the token block.

A token block is valid if
1. All transactions are token chain valid,
2. All transactions are coming from the Bitcoin block that is specified by the Bitcoin block height,
3. It contains the hash value of the previous token block header,
4. The Merkle root of transactions are correctly calculated, and
5. The transaction count is correct.

Therefore, for each blockchain block, there can only be a maximum of one token block, and it is not possible for a token block to include a set of transactions that are coming from two different blockchain blocks.

There is no proof of work on the token chain. However, as all information about the token chain can be derived from the blockchain, the security of the token chain is inherited from the blockchain. Hence, we call it a commensal token chain.

As mentioned above, there are two approaches to create tokens, using coinbase transactions or using normal blockchain transaction. For the blockchain transaction method, the token-creation transactions cannot be validated in the same way as token-spending transactions, because the step that checks the token UTXO set membership will fail. The security of the token chain will be compromised if there is no alternative check on creation transactions.

To address the concern, we describe one security measure for each approach. In the case that the tokens are created by the token issuer in a non-coinbase transaction, we will introduce an identity public key for the token issuer, PKᵢₛₛᵤₑᵣ. To accept a transaction that creates some token, a signature that can be verified by PKᵢₛₛᵤₑᵣ has to be present in the input.

In the case that the tokens are created in a coinbase transaction, then the token creation is as secure as a blockchain block reward. That is, the creation of the token is backed up or justified by the proof of work. However, if the token issuer would like to maintain the control of minting, they can require that a valid token creation transaction has to include a signature from them. This signature can be added in any data field in the coinbase transaction as long as the signed message contains the token output.

Another common security concern would be orphan blocks, which occurs from time to time. The token chain is indeed subject to reorgs as the blockchain. When a valid block or blocks is orphaned due to the presence of another longer chain that has more proof of work, all transactions that are in the block or blocks and not in the other longer chain will return to the mempool. The same applies to the token chain. However, as in many cases, honest users and honest blockchain nodes will not be affected by reorgs as transactions on competing chains will be identical. For the token issuer, they should make sure that the token enabled blockchain nodes who maintain their token chain are connected to the majority of the network in order to have an accurate up-to-date view on their token chain.

To revoke or to burn an issued token is straightforward. One can create a spending transaction that is blockchain valid but token invalid. That is to unlock the blockchain locking condition, but not to unlock the token locking condition. The drawback of this is that the token UTXO set cannot be derived from the token chain alone. The blockchain UTXO set will be required to filter out some revoked entries. However, in practice, the validation process checks blockchain validity first. Therefore, the drawback will have no effect on its computational complexity.

In terms of implementation, the blockchain locking condition can be designed to be unlocked by a multi-sig, which consists of the token issuer, a regulatory entity, and the token owners. It can be 1-out-of-3 so that no entity is required to be online all the time, or 2-out-of-3, where an oracle can be implemented to provide a signature only if the transaction is in the correct format.

When a token solution uses coinbase transactions to create tokens, the token issuer can allow token enabled blockchain nodes to compete to claim some of the newly minted tokens as their rewards. As more blockchain nodes are token enabled in the maintenance of the token chain, all users including the token issuer benefit from the greater availability of the token chain and the greater liquidity of the tokens. Note that even if there is only one blockchain node participating in the token chain, the security is not compromised. It is the availability that is in question.

There are many mechanisms by which the token issuer may reward the token enabled blockchain nodes. Suppose that the token issuer requests that x satoshi from the total output of a coinbase transaction is to represent their tokens.
1. If the token issuer has an off-chain agreement with the token enabled blockchain node, then the newly minted tokens can be set to an output of the token issuer's choice. Moreover, this can be enforced by requiring a signature from the token issuer to be added to the coinbase transaction to attest the legitimacy of the creation of the token.
2. An alternative is to allow the token enabled blockchain node to claim the newly minted tokens themselves as long as the token output in the coinbase transaction follows the format defined above.
3. A combination of the above two would also be an option to create new tokens that are represented by x satoshi.

It is also possible, at the token issuer's choice, not to have competitions. They can choose a subset of the blockchain nodes, like a community in blockchain layered network, to maintain their token chain. Instead of competing, they collaborate to share the reward and provide the availability to the token users.

On the other hand, in the scenario of no competitions, some token enabled blockchain nodes may choose not to execute relevant OP_VER branches to save computational power while claiming they have done so. In this case, a retrospective auditing process can be implemented to catch lazy token enabled blockchain nodes.

Note that the token locking condition in a blockchain output is separated from the blockchain locking condition. The token locking condition can be as simple as P2PKH, or more complex. For example, simply adding multi-sig will allow a more flexible condition to spend the token.

Code Carrier

The blockchain has already provided two means to embed data in transactions. One is to use OP_PUSH and OP_DROP, and the other is to use OP_RETURN. OP_VER will introduce the third mechanism to embed data in transactions. We will explain the differences among the three.
1. OP_PUSH and OP_DROP is generally used in-script. All nodes will execute the opcodes. The data is unlikely to be pruned unless the output is spent.
2. OP_FALSE OP_RETURN is generally used as a stand-alone output, an unspendable output. No nodes will execute the opcodes. The data is likely to be pruned to save storage space.
3. OP_VER will be used in-script. Nodes will have the option to execute the opcodes that come after OP_VERIF. The data is unlikely to be pruned unless the output is spent.
4. As of now, some blockchains also allow the use of OP_RETURN in script. It does not invalidate the execution, but simply exits it when it is called. The validity of the execution depends on what is on the top of the stack when it exits. Therefore, one can use OP_RETURN at the end of the locking script to embed data without affecting the execution of the script.

As we can see, unlike method 1 or 4, OP_VER offers nodes a choice to execute the opcodes by setting their own node version number. Nodes will make the choice depending on their business needs and the economic incentives. For this reason, it is more appropriate to refer to OP_VER as a code carrier instead of a data carrier.

The content that follows OP_VERIF can be any code. Nodes can implement a compiler or a virtual machine that is dedicated to read and run the code. We will explain this in detail with a scenario involving a node Bill 104 and a user Alice 103a.

Suppose Bill 104 broadcasts that he is running a python compiler and is able to execute any python code if users specify node version number “0x31430900” in their blockchain transactions. As a user, Alice 103a creates a transaction TxID₁ followed by a spending transaction TxID₂ to check out Bill's service.

TxID₁

| Version | 1 | Locktime | 0 |
|---|---|---|---|
| In-count | 1 | Out-count | 1 |
| Input list | | Output list | |
| Outpoint | Unlocking script | Value | Locking script |
| Outpoint | < Sig_{A} >< PK_{A} > | x satoshi | OP_DUP OP_HASH160 <H(PK₁)> |
| from | | | OP_EQUALVERIFY OP_CHECKSIG |
| Alice | | | <0x31430900> OP_VERIF |
| | | | OP_VERIFY |
| | | | [python code] |
| | | | OP_ENDIF |

TxID₂

| Version | 1 | Locktime | 0 |
|---|---|---|---|
| In-count | 1 | Out-count | 1 |
| Input list | | Output list | |
| Outpoint | Unlocking script | Value | Locking script |
| TxID₁\|\|0 | < data₁ > | x satoshi | OP_DUP OP_HASH160 <H(PK₂)> |
| | < Sig₁ >< PK₁ > | | OP_EQUALVERIFY OP_CHECKSIG |

When Bill 104 receives TxID₂, he will execute the input script from TxID₂ with the output script from TxID₁: <data₁><Sig₁><PK₁>OP_DUP OP_HASH160<H(PK₁)>OP_EQUALVERIFY OP_CHECKSIG<0x31430900>OP_VERIF OP_VERIFY [python code] OP_ENDIF

After Bill 104 has successfully verified the signature Sig₁, what is left to be executed is: <0x31430900>OP_VERIF OP_VERIFY [python code] OP_ENDIF

Note that the result of OP_CHECKSIG and data₁ are the top 2 elements on the main stack at this moment. Then <0x31430900>OP_VERIF will allow Bill 104 to call OP_VERIFY to consume the “true” or “false” element on top of the stack and read the python code that is embedded in the script. Bill 104 compiles the python code and runs the code on the input data₁, which is now on top of the stack. So far, the process we have described is generic to any implementation. The rest of the process, however, can differ from case to case. In short, Bill 104 records the output of the Python code, out₁. To elaborate a bit, there are many ways to record out₁. For example, Bill 104 can send it to Alice 103a in a private communication channel, or A Bill 104 lice can maintain a chain of outputs for Alice 103a to access at any time. We choose to describe in detail one of the many ways which we consider as an advantageous way to record out₁.

Bill 104 can record out, in a blockchain transaction and publish the transaction on the blockchain. In fact, Bill 104 can record out, in TxID₂. In order to do this, we require Alice 130a to use SIGHASH flags, SIGHASH_SINGLE and SIGHASH_ANYONECANPAY (S|ACP) in his signature in TxID₂, and send TxID₂ to Bill 104 directly in a secure channel. After obtaining the output out₁, Bill 104 updates TxID₂ by adding an input and an output to finalise the transaction (using SIGHASH_ALL):

TxID′₂

| Version | 1 | Locktime | 0 |
|---|---|---|---|
| In-count | 2 | Out-count | 2 |
| Input list | | Output list | |
| Outpoint | Unlocking script | Value | Locking script |
| TxID₁\|\|0 | < data₁ > | x satoshi | OP_DUP OP_HASH160 <H(PK₂)> |
| | < Sig₁ >< PK₁ > | | OP_EQUALVERIFY OP_CHECKSIG |
| outpoint | < Sig_{A} >< PK_{A} > | 0 | OP_FALSE OP_RETURN <out₁> |
| from Bill | | | |

Since Alice added her digital signature, she will be held responsible for the correctness of out₁ either from a legal perspective or a reputation and business perspective.

Moreover, out, is verifiable. All information required to verify out, is in TxID₂′. The python code can be called via the reference of TxID₁∥0 in the input. The input to the python code data₁ can also be found in the input of the transaction. As all the information is also on chain, it provides an easy way to audit.

For these reasons, Bob can be convinced that outᵢ will be the output of his python code given the input being data₁.

When Alice 103a signed TxID₂ using S|ACP, anyone who sees the transaction can update it by adding more inputs or outputs. Also, if another node sees the transaction and publishes it before Bill 104 does, then Bill 104 will not be able to update the transaction anymore. This is why we require Alice 130a to send TxID₂ directly to Bill 104 in a secure channel. As a node, Bill 104 can publish the transaction before broadcasting them.

An extension to this approach is to have more than one node like Bill 104. Alice 103a can either send the same transaction to different nodes for them to compete or send different transactions (with the same python code and input) to different nodes and hope the outputs he gathered are the same.

We can also incorporate a payment channel between Bill 104 and Alice 130a, in this case, a sequence of smart contracts can be executed within the payment channel. For example, the output of TxID₂ can be of the same form as the output of TxID₁ containing some other python code, and out, can be the input data for the python code. This creates a chain of transactions within the payment channel.

When creating TxID₂, Alice 103a can ensure that it includes a service fee for Bill 104. This can be in the form of a transaction fee (input value−output value), or Bill 104 can add a change address to claim the fee directly. The former would require Bill 104 to wait for 100 blocks (roughly under 17 hours) to be able to spend the reward, while the latter allows Bill 104 to spend it straight away.

On Ethereum, a user creates a smart contract account with some code written in Solidity. When users send transactions to that account, the code will be executed by all Ethereum miners, and the new state (output) is recorded on chain. In our paradigm, a user creates a smart contract transaction with some code that can be written in any programming language (flexibility). The output of this transaction can specify who can access this smart contract by using multi-sig or threshold signatures or other similar tricks. When spending the smart contract transaction, the code will be executed by selective blockchain nodes based on nodes' own choices (efficiency), and the output is recorded on chain. As we can see from the description above, our scheme is more flexible, more efficient, and most importantly, much more scalable.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises:
executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.

Statement 2. The method of statement 1, comprising validating the second transaction based on said execution of the first locking script together with the first unlocking script.

Statement 3. The method of any preceding statement, wherein said outputting of the node protocol version number comprises outputting a fixed-length representation of the node protocol version number.

Statement 4. The method of any preceding statement, wherein the first locking script is written in a stack-based scripting language, and wherein said outputting of the node protocol version number comprises outputting the node protocol version number to a stack.

Statement 5. The method of any preceding statement, wherein the first locking script or the first unlocking script comprises a target node protocol version number, and wherein said execution of the version opcode comprises determining whether the output node protocol version number matches the target node protocol version number.

Statement 6. The method of statement 5, wherein said execution of the version opcode comprises:
if the output node protocol version number does match the target node protocol version number, executing a predetermined portion of the locking script, and
if the output node protocol version number does not match the target node protocol version number, not executing the predetermined portion of the locking script.

The predetermined portion of the locking script may be a portion of script immediately following the version opcode.

Statement 7. The method of statement 6, wherein the first locking script comprises a code separator opcode separating the predetermined portion of script and a second portion of script such that a signature included in the first unlocking script signs only the second portion of script and not the predetermined portion of script.

For instance, the code separator opcode may be OP_CODESEPARATOR. The second portion of script may comprises a pay-to-public-key hash script.

Statement 8. The method of statement 6 or statement 7, comprising outputting and/or storing a result of said execution of the predetermined portion of the locking script.

Statement 9. The method of any of statements 6 to 8, wherein the predetermined portion of script comprises a portion of code written in a language other than a native blockchain language, and wherein the blockchain node is configured to execute code written in that language.

Statement 10. The method of statement 9, wherein the portion of code is written in a blockchain language other than the native blockchain language.

Statement 11. The method of statement 8 or any statement dependent thereon, wherein said outputting of the result comprises transmitting the result to a first user.

Statement 12. The method of statement 11, wherein the first and/or second transaction is generated by the first user.

Statement 13. The method of statement 8 or any statement dependent thereon, wherein said outputting of the result comprises storing the result in a blockchain transaction and making the blockchain transaction available to one or more nodes of the blockchain network.

Statement 14. The method of statement 12 and statement 13, wherein the second transaction is received from the first user, and wherein the method comprises updating the second transaction to include the result.

Statement 15. The method of any preceding statement, comprising:
generating a third blockchain transaction, wherein the third transaction comprises an output comprising a locking script, and wherein the locking script comprises the version opcode; and
making the third blockchain transaction available to one or more nodes of the blockchain network.

In some examples, the third blockchain transaction may be a coinbase transaction.

Statement 16. The method of statement 15, wherein the locking script comprises a respective target version number and a portion of code, wherein the version opcode is configured so as when executed alongside an input of a later transaction, to determine whether a node protocol version number output during execution of the version opcode matches the respective target node protocol version number, and to only execute the portion of the code on condition that the output node protocol version number matches the respective target node protocol version number.

Statement 17. The method of statement 16, wherein the portion of code comprises a locking condition based on a public key or a hash of a public key.

Statement 18. The method of any of statements 15 to 17, wherein the third transaction is a token creation transaction, and wherein the respective target version number is associated with a token protocol.

Statement 19. The method of statement 6 or any statement dependent thereon, wherein the first and second transactions are respective token transactions, wherein the target node protocol version number is associated with a token protocol, and wherein the portion of code comprises a locking condition based on a public key or a hash of a public key.

Statement 20. The method of statement 19, comprising constructing a respective token block for a respective blockchain block, wherein the token block comprises one, some or all of:
the target node protocol version number associated with the token protocol,
each transaction comprising the target version number and published in the respective blockchain block,
a sum of the number of transactions contained in the token block,
a Merkle root calculated based on the transactions included in the token block, and
a previous block header based on a hash of a previous token block constructed based on a corresponding previous blockchain block.

Statement 21. The method of statement 20, comprising storing and/or outputting the respective token block.

Statement 22. A computer-implemented method of generating blockchain transactions, wherein the method is performed by a generating entity and comprises:
generating a first blockchain transaction comprising a first output, wherein the first output comprises a first locking script comprising a version opcode, wherein the version opcode is configured, so as when executed by an executing entity, to cause the executing entity to obtaining a node protocol version number of the blockchain node, and output the node protocol version number, and wherein the node protocol version number is associated with a particular functionality that the blockchain node is configured to execute.

Statement 23. The method of statement 22, comprising making the first blockchain transaction available to one or more nodes of the blockchain network.

Statement 24. The method of statement 22 or statement 23, wherein the first locking script comprises a target node protocol version number, and wherein the version opcode is configured to cause the blockchain node to determine whether the output node protocol version number matches the target node protocol version number.

Statement 25. The method of statement 24, wherein the version opcode is configured to cause the blockchain node to execute a predetermined portion of the locking script if the output node protocol version number does match the target version number.

Statement 26. The method of statement 25, wherein the predetermined portion of script comprises a portion of code written in a language other than a native blockchain language.

Statement 27. The method of statement 26, wherein the portion of code is written in a blockchain language other than the native blockchain language.

Statement 28. The method of statement 25, wherein the portion of code comprises a locking condition based on a public key or a hash of a public key.

Statement 29. The method of statement 28, wherein the first transaction is a token creation transaction or a token spend transaction, and wherein the respective target node protocol version number is associated with a token protocol.

Statement 30. The method of any preceding statement, wherein the version opcode is one of OP_VER, OP_VERIF or OP_VERIFNOT.

Statement 31. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 32. A computer program embodied on computer-readable storage and configured so as, when run on one or more processors, to perform the method of any of statements 1 to 30.

According to another aspect disclosed herein, there may be provided a method comprising the actions of the blockchain node and the generating entity.

According to another aspect disclosed herein, there may be provided a system comprising the computer equipment of the blockchain node and the generating entity.

1. A computer-implemented method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises:
executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.

2. The method of claim 1, comprising validating the second transaction based on said execution of the first locking script together with the first unlocking script.

3. The method of claim 1, wherein said outputting of the node protocol version number comprises outputting a fixed-length representation of the node protocol version number.

4. The method of claim 1, wherein the first locking script is written in a stack-based scripting language, and wherein said outputting of the node protocol version number comprises outputting the node protocol version number to a stack.

5. The method of claim 1, wherein the first locking script or the first unlocking script comprises a target node protocol version number, and wherein said execution of the version opcode comprises determining whether the output node protocol version number matches the target node protocol version number.

6. The method of claim 5, wherein said execution of the version opcode comprises:
if the output node protocol version number does match the target node protocol version number, executing a predetermined portion of the locking script, and
if the output node protocol version number does not match the target node protocol version number, not executing the predetermined portion of the locking script.

7. The method of claim 6, wherein the first locking script comprises a code separator opcode separating the predetermined portion of script and a second portion of script such that a signature included in the first unlocking script signs only the second portion of script and not the predetermined portion of script.

8. The method of claim 6, comprising outputting and/or storing a result of said execution of the predetermined portion of the locking script, wherein said outputting of the result comprises storing the result in a blockchain transaction and making the blockchain transaction available to one or more nodes of a blockchain network.

9. The method of claim 6, wherein the predetermined portion of script comprises a portion of code written in a language other than a native blockchain language, and wherein the blockchain node is configured to execute code written in that language.

10. The method of claim 9, wherein the portion of code is written in a blockchain language other than the native blockchain language.

11-14. (canceled)

15. The method of claim 1, comprising:
generating a third blockchain transaction, wherein the third transaction comprises an output comprising a locking script, and wherein the locking script comprises the version opcode; and
making the third blockchain transaction available to one or more nodes of a blockchain network.

16. The method of claim 15, wherein the locking script comprises a respective target version number and a portion of code, wherein the version opcode is configured so as when executed alongside an input of a later transaction, to determine whether a node protocol version number output during execution of the version opcode matches the respective target node protocol version number, and to only execute the portion of the code on condition that the output node protocol version number matches the respective target node protocol version number.

17. The method of claim 16, wherein the portion of code comprises a locking condition based on a public key or a hash of a public key.

18. (canceled)

19. The method of claim 6, wherein the first and second transactions are respective token transactions, wherein the target node protocol version number is associated with a token protocol, and wherein the portion of code comprises a locking condition based on a public key or a hash of a public key.

20. The method of claim 19, comprising constructing a respective token block for a respective blockchain block, wherein the token block comprises one, some or all of:
the target node protocol version number associated with the token protocol,
each transaction comprising the target version number and published in the respective blockchain block,
a sum of the number of transactions contained in the token block,
a Merkle root calculated based on the transactions included in the token block, and
a previous block header based on a hash of a previous token block constructed based on a corresponding previous blockchain block.

21. The method of claim 20, comprising storing and/or outputting the respective token block.

22. A computer-implemented method of generating blockchain transactions, wherein the method is performed by a generating entity and comprises:
generating a first blockchain transaction comprising a first output, wherein the first output comprises a first locking script comprising a version opcode, wherein the version opcode is configured, so as when executed by an executing entity, to cause the executing entity to obtaining a node protocol version number of the blockchain node, and output the node protocol version number, and wherein the node protocol version number is associated with a particular functionality that the blockchain node is configured to execute.

23-29. (canceled)

30. The method of claim 1, wherein the version opcode is one of OP_VER, OP_VERIF or OP_VERIFNOT.

31. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises:
executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.

32. A computer program embodied on a non-transitory computer-readable storage medium and configured so as, when run on one or more processors, the one or more processors perform a method of executing blockchain transactions, wherein a first blockchain transaction comprises a first output, wherein the first output comprises a first locking script comprising a version opcode, wherein a second transaction comprises a first input that references the first output of the first transaction and comprises a first unlocking script, and wherein the method is performed by a blockchain node and comprises:
executing the first locking script together with the first unlocking script, wherein said execution comprises, upon executing the version opcode, obtaining a node protocol version number of the blockchain node, and outputting the node protocol version number, wherein the node protocol version number is associated with a particular functionality that the blockchain node is configured to execute.
